(19) United States
(12) Patent Application Publication
(10) Pub. No.: US 2021/0366142 A1
(43) Pub. Date: Nov. 25, 2021

(54) DYNAMIC DEPTH DETERMINATION

(71) Applicant: Facebook Technologies, LLC, Menlo Park, CA (US)

(72) Inventors: Nadav Grossinger, Foster City, CA (US); Michael Hall, Bellevue, WA (US); Robert Hasbun, San Jose, CA (US); Niv Kantor, San Francisco, CA (US); Arthur Benjamin Nieuwoudt, San Carlos, CA (US); Shuochen Su, Seattle, WA (US); Andrey Tovchigrechko, Saratoga, CA (US); Yue Zhao, Union City, CA (US)

(21) Appl. No.: 17/329,888

(22) Filed: May 25, 2021

Related U.S. Application Data
(60) Provisional application No. 63/049,252, filed on Jul. 8, 2020.
(60) Provisional application No. 63/030,119, filed on May 26, 2020.

(51) Int. Cl. G06T 7/593; H04N 13/254; H04N 13/239; H04N 13/296; G06T 7/521; H04N 13/246; H04N 13/271

(52) U.S. Cl. CPC G06T 7/593; H04N 13/254; H04N 13/239; G06T 2207/20081; G06T 7/521; H04N 13/246; H04N 13/271; H04N 13/296

(57) ABSTRACT

A depth camera assembly (DCA) determines depth information for a local area. The DCA includes a plurality of cameras and at least one illuminator. The DCA dynamically determines depth sensing modes (e.g., passive stereo, active stereo, structured stereo) based in part on the surrounding environment and/or user activity. The DCA uses the depth information to update a depth model describing the local area. The DCA may determine that a portion of the depth information associated with some of portion of the local area is not accurate. The DCA may then select a different depth sensing mode for the portion of the local area and update the depth model with the additional depth information. In some embodiments, the DCA may update the depth model by utilizing a machine learning model to generate a refined depth model.

### CROSS-REFERENCE TO RELATED APPLICATIONS

This application claims the benefit of U.S. Provisional Application No. 63/049,252, filed Jul. 8, 2020, and U.S. Provisional Application No. 63/030,119, filed May 26, 2020, which are incorporated by reference in their entirety.

### FIELD OF THE INVENTION

This disclosure relates generally to depth determination, and more specifically to dynamic depth determination for artificial reality systems.

### BACKGROUND

Depth determination is utilized in a wide range of applications, such as artificial reality, autonomous driving, 3D mapping, robotics, and more. Conventional depth determination techniques may be cost-prohibitive, inaccurate, and/or consume high amounts of power to perform. For example, a depth sensing system used to determine depth information for a local area may use structured light which has good depth resolution irrespective of ambient light levels but consumes more power than a stereo based depth sensing system. Likewise, a stereo based depth sensing system (without an active illuminator) may perform well when the local area is well lit and be relatively low power; however, have poor depth resolution for dark areas in the local area. Additionally, depth sensing systems that employ conventional machine learning models to determine depth information, oftentimes, demand large amounts of computation time consuming more power and require careful calibration. Accordingly, it can be challenging to determine depth of objects in a local area accurately while using low power.

### SUMMARY

A depth camera assembly (DCA) determines depth information for a local area. The DCA includes a plurality of cameras and at least one illuminator. The DCA dynamically determines depth sensing modes (e.g., passive stereo, active stereo, structured stereo) based in part on the surrounding environment and/or user activity. During operation of the DCA in any of the depth sensing modes, the plurality of cameras captures a set of images of the local area. The DCA determines depth information for the local area based on the depth sensing mode. The depth information is used, by the DCA, to generate or update a depth model describing the local area.

The DCA may update some or all of the depth model by selecting a different depth sending mode and/or by utilizing a machine learning model to generate a refined depth model. For example, the DCA may determine that some or all of the depth information associated with the depth model of the local area is not accurate. In some embodiments, the DCA may select a different depth sensing mode to capture images of one or more regions of the local area and update the depth model with the additional depth information. In some embodiments, the DCA may utilize the machine learning model to generate the refined depth model. In other embodiments, the DCA may select a different depth sensing mode and utilize a machine learning model to update the depth model. In some embodiments, the DCA may perform a calibration using stereo depth information and structured light depth information from each camera.

In some embodiments, a method may comprise determining a depth sensing condition for a first portion of a depth model. The first portion of the depth model may correspond to a first region of a local area. A DCA may select a depth sensing mode for the first region based in part on the depth sensing condition, wherein the depth sensing mode is selected from a plurality of different depth sensing modes. The DCA determines depth information for at least the first region using the selected depth sensing mode. The DCA updates the first portion of the depth model using the determined depth information. In some embodiments, the DCA updates the depth model using a machine learning model to generate a refined depth model.

In some embodiments, a DCA comprises a first camera, a second camera, an illuminator, and a controller. The controller is configured to determine a depth sensing condition for a first region of a local area, select a depth sensing mode for the first region based in part on the depth sensing condition, instruct the illuminator to project light into the first region based on the depth sensing mode, and obtain depth information for the first region based on reflected light detected by the first camera and the second camera. In some embodiments, the controller is further configured to update a first portion of a depth model that corresponds to the first region of the local area based on the depth information. In some embodiments, the controller is further configured to update the depth model by utilizing a machine learning model to generate a refined depth model.

In some embodiments, a computer program product comprises a non-transitory computer-readable storage medium containing computer program code. The computer program code comprises a depth selection module configured to: determine a depth sensing condition for a first portion of a depth model, the first portion of the depth model corresponding to a first region of a local area; and select a depth sensing mode for the first region based in part on the depth sensing condition, wherein the depth sensing mode is selected from a plurality of different depth sensing modes. The computer program code comprises a depth measurement module configured to determine depth information for at least the first region using the selected depth sensing mode. The computer program code comprises a depth mapping module configured to update the first portion of the depth model using the determined depth information. In some embodiments, the depth mapping module is further configured to update the depth model by utilizing a machine learning model to generate a refined depth model.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of a depth camera assembly, in accordance with one or more embodiments.

FIG. 3 is a schematic diagram of a depth camera assembly in a local area, in accordance with one or more embodiments.

FIG. 4 is a flowchart illustrating a process for selecting a depth determination method, in accordance with one or more embodiments.

FIG. 5 is a flowchart illustrating a process for generating a refined depth model, in accordance with one or more embodiments.

FIG. 6A is a process flow diagram for a machine learning model, in accordance with one or more embodiments.

FIG. 6B illustrates an example architecture for the machine learning model of FIG. 6A.

FIG. 6C illustrates example inputs and an example output for the machine learning model of FIG. 6A.

FIG. 7 is a flowchart illustrating a process for calibrating a depth camera assembly, in accordance with one or more embodiments.

FIG. 8 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

The patent or application file contains at least one drawing executed in color. Copies of this patent or patent application publication with color drawing(s) will be provided by the Office upon request and payment of the necessary fee.

### DETAILED DESCRIPTION

A depth camera assembly (DCA) determines depth information for a local area. The depth information describes the locations of objects in a three-dimensional space. The DCA includes a plurality of cameras and at least one illuminator. The plurality of cameras captures a set of images of the local area. The DCA is capable of obtaining depth information, based on the set of captured images, in multiple different modes. A passive stereo mode may be preferable due to its low power consumption for depth sensing in well-lit areas. An active stereo mode may consume more power than a passive stereo mode, but the active stereo mode may provide more accurate measurements, particularly in dark areas where additional light adds texture to the area. A structured stereo mode may consume more power than the active stereo mode, but the structured stereo mode may provide greater resolution in the depth measurements, and thus may be preferable when a high level of resolution is preferable.

The DCA dynamically determines depth sensing modes (e.g., passive stereo, active stereo, structured stereo) based in part on the surrounding environment and/or user activity. The DCA may switch between depth sensing modes when preferable. The DCA may use different depth sensing modes for different portions of the local area. The DCA uses the depth information to update a depth model describing the local area. The DCA can monitor the depth information for quality. The level of quality may include the uncertainty of a depth measurement and resolution of depth measurements.

Based on the level of quality, the DCA may determine to update the depth model. In some embodiments, the DCA may select a different depth sensing mode for a portion of the local area and update the depth model with the additional depth information. In other embodiments, the DCA may utilize a machine learning model to update the depth model by generating a refined depth model. For example, the DCA may determine a confidence map associated with the depth model and may input the depth model, the confidence map, and the set of captured images into the machine learning model. The machine learning model outputs the refined depth model. In yet other embodiments, the DCA may select a different depth sensing mode for a portion of the local area and utilize the machine learning model to update the depth model.

The DCA discussed herein improves the performance of DCAs over systems that utilize a single depth sensing mode and/or utilize computationally complex machine learning models for depth determinations. For example, the DCA may decrease power consumption by using lower-power depth sensing modes for portions of the local area for which the DCA may determine depth information is above a threshold level of quality. Additionally, the DCA may increase the quality level of depth information by selecting a depth sensing mode for portions of the local area for which a lower-power depth sensing mode is unsuitable for determining depth information above a threshold level of quality. Further, the DCA can update a depth model by utilizing a machine learning model that does not consume large amount of power nor require careful calibration. The machine learning model can provide more consistent and accurate depth determinations regardless of surface textures, repeating surfaces, and/or dark-colored objects being present in the set of captured images.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

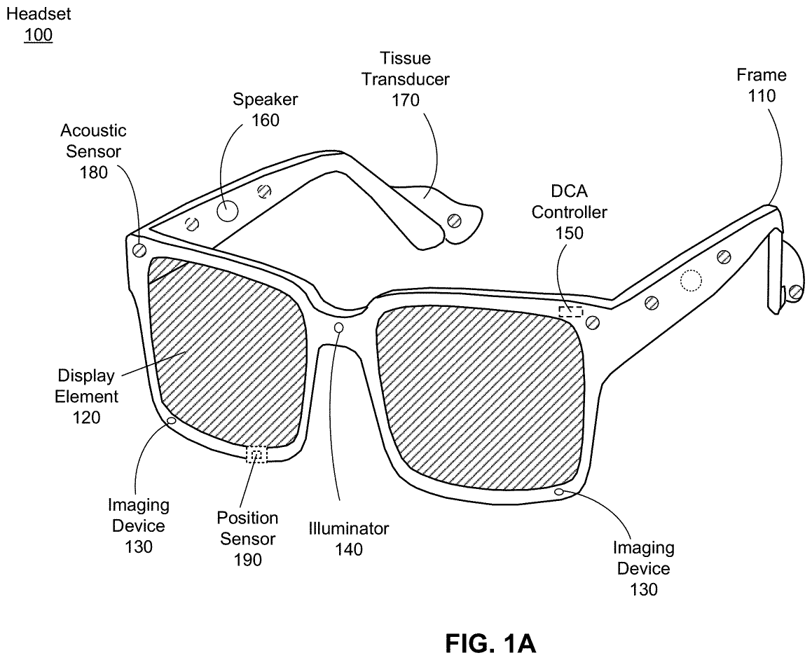

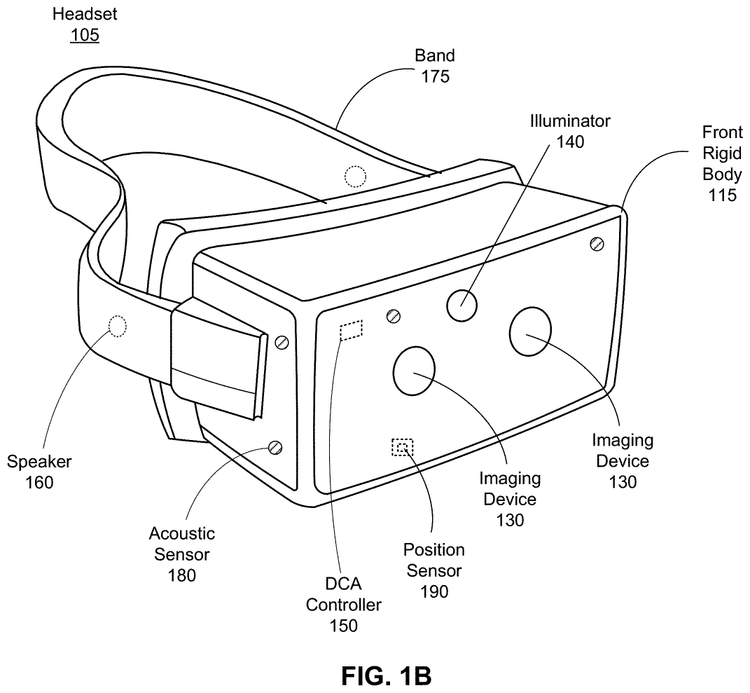

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame 110, and may include, among other components, a display assembly including one or more display elements 120, a DCA, an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130, a DCA controller 150, and an illuminator 140. In some embodiments, the illuminator 140 illuminates a portion of the local area with light. The light may be, e.g., structured light (e.g., dot pattern, bars, etc.) in the infrared (IR), uniform light illuminating a scene, IR flash for time-of-flight, etc. In some embodiments, the one or more imaging devices 130 capture a set of images of the portion of the local area that include the light from the illuminator 140. As illustrated, FIG. 1A shows a single illuminator 140 and two imaging devices 130.

The DCA controller 150 computes depth information for the portion of the local area using the set of captured images and one or more depth sensing modes. The depth sensing mode may be, e.g., direct time-of-flight (ToF) depth sensing, indirect ToF depth sensing, structured light, passive stereo analysis, active stereo analysis (uses texture added to the scene by light from the illuminator 140), some other mode to determine depth of a scene, or some combination thereof.

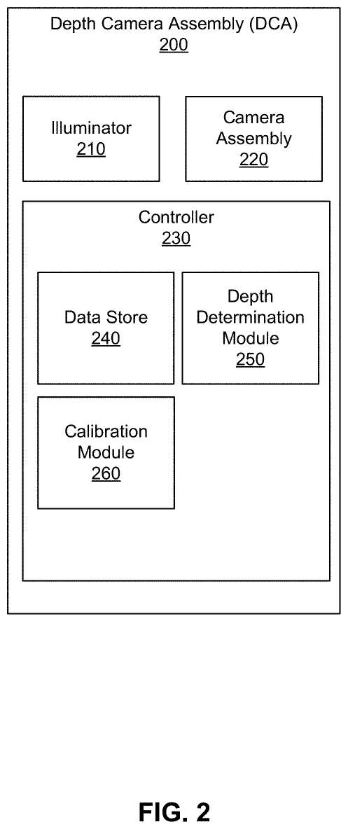

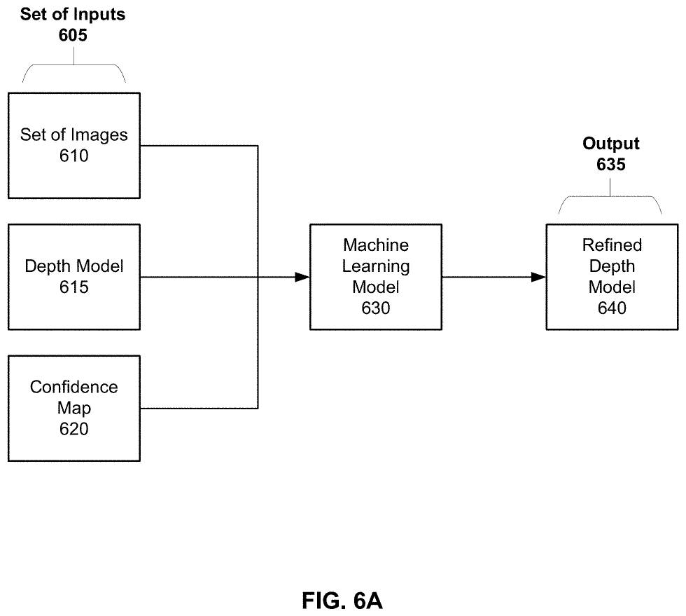

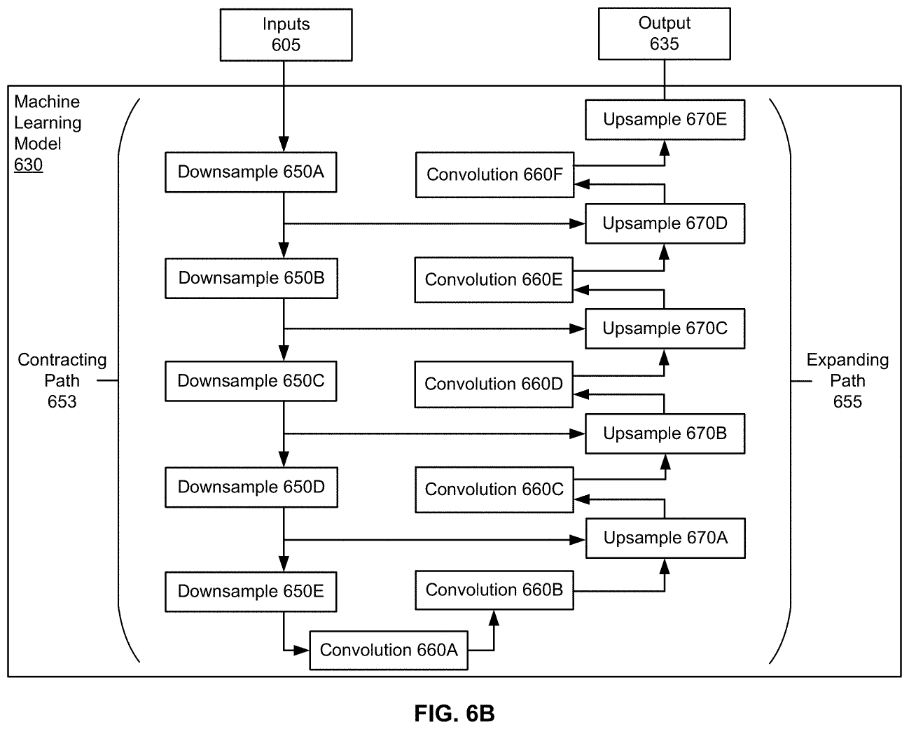

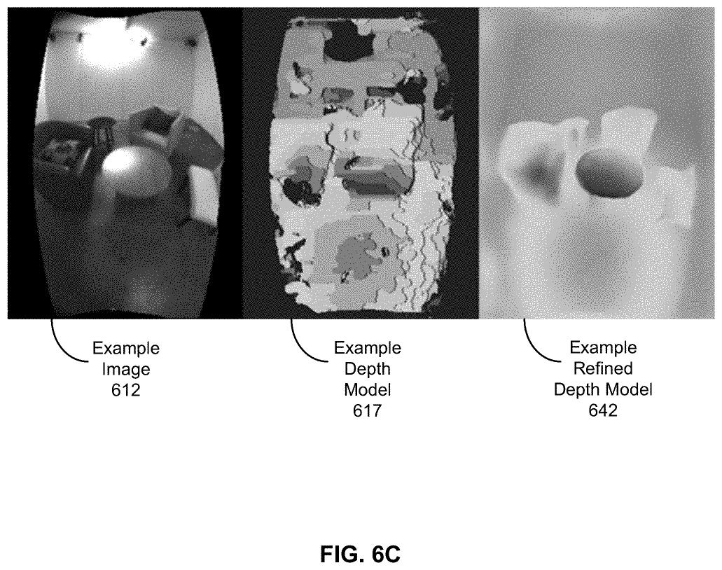

The DCA controller 150 selects one or more depth sensing modes for the local area. The depth sensing mode may be selected based on a depth sensing condition. A depth sensing condition is a parameter that affects the selection of a depth sensing mode. A depth sensing condition may be, e.g., an environmental condition of the local area (e.g., an ambient light level), a location of objects in the local area (e.g., the distance to an object from the DCA), a function being performed by the DCA (e.g., a VR game), a power supply availability do the DCA (e.g., a battery level), a preferable level of quality of depth measurements (e.g., a maximum acceptable uncertainty), some other condition that affects the selection of a depth sensing mode, or some combination thereof. The DCA controller 150 obtains the depth information using the selected depth sensing modes. The DCA controller 150 creates or updates a depth model describing the local area based on the depth information. A portion of the depth model may be obtained using a first depth sensing mode, and different portion of the depth model may be obtained using a second depth sensing mode. In some embodiments, the DCA controller 150 updates the depth model by utilizing a machine learning model to generate a refined depth model (i.e., an updated depth model). The machine learning model is further discussed below with regard to, e.g., FIG. 2 and FIGS. 6A-6C.

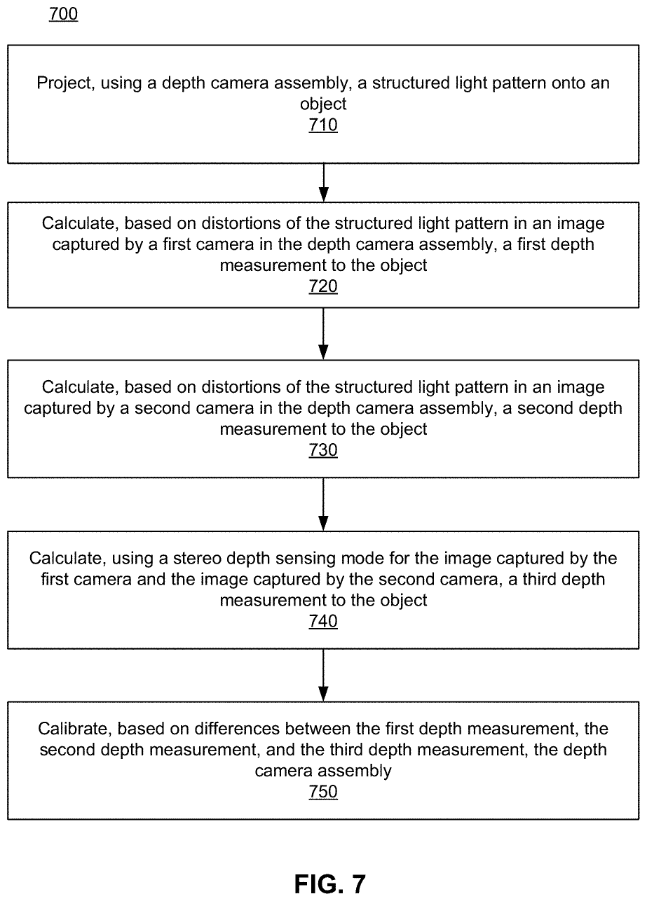

The DCA controller 150 may calibrate the DCA. The alignment between the different imaging devices 130 of the DCA may change due to a change in shape of one or more components of the headset 100. The DCA controller 150 may calculate depth measurements using different depth sensing modes. The DCA controller 150 calibrates the DCA based on the different depth measurements. Calibration is further discussed below with regard to, e.g., FIG. 2 and FIG. 7.

The audio system provides audio content. The audio system includes a transducer array, a sensor array, and an audio controller (not shown). However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., in the room). Each acoustic sensor 180 is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller processes information from the sensor array that describes sounds detected by the sensor array. The audio controller may comprise a processor and a computer-readable storage medium. The audio controller may be configured to generate direction of arrival (DOA) estimates, generate acoustic transfer functions (e.g., array transfer functions and/or head-related transfer functions (HRTFs)), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

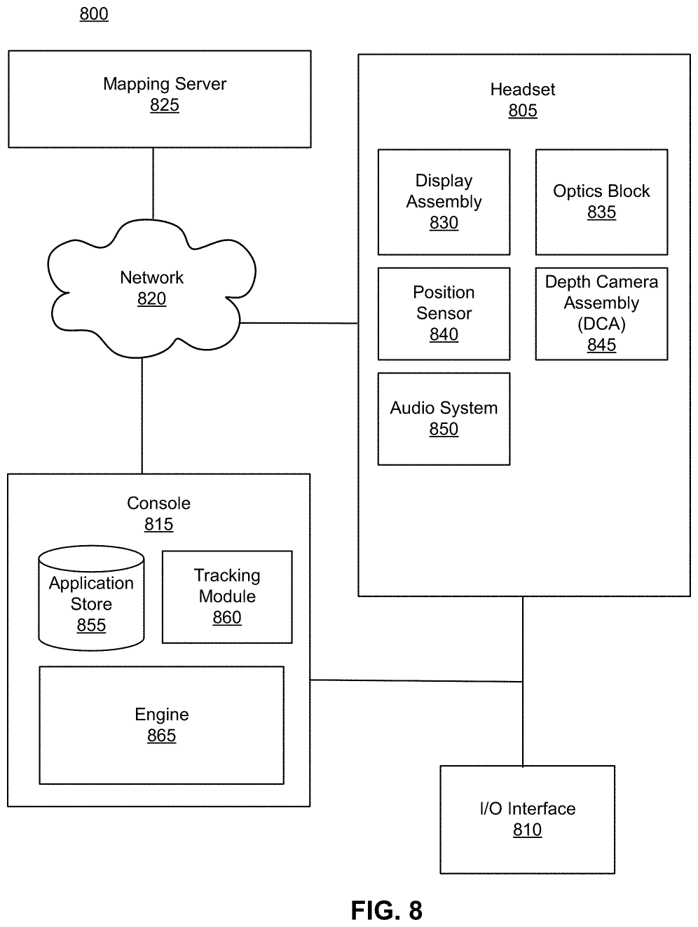

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area (e.g., the depth model), update a model of the local area, or some combination thereof. Furthermore, the position sensor 190 tracks the position (e.g., location and pose) of the headset 100 within the room. Additional details regarding the components of the headset 100 are further discussed below with regard to, e.g., FIG. 8.

FIG. 1B is a perspective view of a headset 105 implemented as an HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The DCA controller 150 is configured to select a depth sensing mode for the DCA based on a depth sensing condition in the local area. The DCA controller 150 is further configured to calibrate the DCA and update a depth model.

FIG. 2 is a block diagram of a depth camera assembly (DCA) 200, in accordance with one or more embodiments. The DCA of FIG. 1A and FIG. 1B may be an embodiment of the DCA 200. The DCA 200 is configured to obtain depth information of a local area surrounding the DCA 200. For example, the DCA 200 may be configured to detect the location of objects in a room. The DCA 200 comprises an illuminator 210, a camera assembly 220, and a controller 230. Some embodiments of the DCA 200 have different components than those described here. For example, in some embodiments, the illuminator 210 and/or the camera assembly 220 may be incorporated on a first device that is separate from and communicates with the controller 230 that is incorporated on a second device. Similarly, in some cases, functions can be distributed among the components in a different manner than is described here. The DCA 200 may be a component of a headset device (e.g., the headset 100 or the headset 105) or a component of a mobile device. (e.g., a smartphone).

The illuminator 210 is configured to project light into the local area. The illuminator 140 of FIG. 1A and FIG. 1B may be an embodiment of the illuminator 210. The light may be, e.g., structured light (e.g., dot pattern, bars, etc.) in the infrared (IR). The projected light reflects off objects in the local area, and a portion of the reflected light is detected by the DCA 200. In some embodiments, the illuminator 210 may project distinctly shaped features, such as crosses, triangles, squares, sinusoidal shapes, etc., such that the DCA 200 may determine that the reflected light was emitted by the illuminator 210 and not by a different source. In some embodiments, the illuminator 210 may project temporally coded light. For example, the illuminator 210 may project blinking light at known intervals, such that the DCA 200 may determine that the reflected light was emitted by the illuminator 210. The illuminator 210 may selectively illuminate portions of the field of view of the illuminator. In some embodiments, the illuminator 210 may project light into a first portion of the local area without projecting light into a second portion of the local area. In some embodiments, the illuminator 210 may project a first light pattern into a first portion of the local area and a second light pattern into a second portion of the local area.

The camera assembly 220 is configured to capture a set of images for the local area. The camera assembly 220 comprises a plurality of cameras. The imaging devices 130 of FIG. 1A and FIG. 1B may be an embodiment of the cameras of the camera assembly 220. Some of the cameras may have overlapping fields of view for stereo depth determination. Each camera comprises one or more sensors. In some embodiments, each sensor may comprise a charge-coupled device (CCD) or a complementary metal-oxide-semiconductor (CMOS). Each sensor comprises a plurality of pixels. Each pixel is configured to detect photons incident on the pixel. The pixels are configured to detect a narrow bandwidth of light including the wavelength of the light projected by the illuminator 210. Each pixel may correspond to a distinct direction relative to the camera assembly 220. Two or more cameras may be configured to capture images simultaneously. The two or more cameras may be configured to have overlapping fields of view. Each camera is located in a different position. The set of images captured by the camera assembly 220 may be monochrome images and/or RGB images. The images may be analyzed together in stereo depth sensing modes to calculate distances to objects in the local area. Each camera may be utilized independent from the other camera(s) in some depth sensing modes, such as TOF or structured light depth sensing modes.

The controller 230 is configured to control operations of the DCA 200. The DCA controller 150 of FIG. 1A and FIG. 1B may be an embodiment of the controller 230. The controller 230 includes a data store 240, a depth determination module 250, and a calibration module 260. Some embodiments of the controller 230 have different components than those described here. Similarly, functions can be distributed among the components in different manners than described here.

The data store 240 is configured to store data structures which may be used by the controller 230. The data store 240 stores a depth model of the local area. The depth model describes a three-dimensional model of the local area. For example, the depth model may be a depth map of the local area. The depth model may additionally comprise depth sensing conditions describing the local area. In some embodiments, the data store 240 may transmit to and receive depth model information from a mapping server. The data store 240 stores depth information for locations in the local area.

The data store 240 may store quality values for locations in the local area. In some embodiments, the quality values may be scalar uncertainty values, such as an object may be located within +/−5 cm of a specified location. In some embodiments, the quality values may include uncertainty grades for regions in the local area. For example, the grades may range from 0-10, with 0 representing a high level of uncertainty for the depth values in a region, and 10 representing a high level of certainty for a depth value in a region. The data store 240 may store confidence maps associated with depth models of the local area. The confidence maps may include a confidence value per pixel of a depth model. The data store 240 may store threshold confidence values and threshold quantity values. The threshold values may be used by the DCA 200 to determine when to update a depth model of the local area.

The data store 240 may obtain depth information regarding the local area from a mapping server. The mapping server may store depth model information for a plurality of areas. The data store 240 may provide location information, such as GPS coordinates, to the mapping server, and the mapping server may provide depth information to the data store 240 based on the location information. In some embodiments, the data store 240 may generate a depth model for a local area that does not have an existing depth model.

The data store 240 may store images of the local area. The images may be used by the DCA 200 to calculate depth information. The data store 240 may store one or more camera parameters about the camera assembly 220. The one or more camera parameters may include intrinsic parameters, extrinsic parameters, and a distortion model that describe the camera assembly 220. The one or more camera parameters may be used by the DCA 200 to rectify a set of captured images of the local area.

The depth determination module 250 is configured to determine depth information. The depth determination module 250 is configured to calculate depth information based on the information obtained by the camera assembly 220. The depth determination module 250 may determine depth measurements using a selected depth sensing mode. The depth sensing mode may be, for example, TOF depth sensing, passive stereo depth sensing, active stereo depth sensing, structured stereo depth sensing, or some combination thereof.

The depth determination module 250 is configured to select a depth sensing mode for one or more regions of the local area. The depth determination module 250 calculates the depth measurements using the selected depth sensing mode. Depth measurements may include one or more distances between a device the DCA is a component of and one or more real-world objects in the local area, one or more distances between two or more real-world objects in the local area, an orientation of the user of the device the DCA is a component of in the local area, and so on. The depth measurements may be used by the device the DCA is a component of to present virtual reality (VR) content or augmented reality (AR) content to the user.

The depth determination module 250 may determine depth information using a default depth sensing mode. For example, the default depth sensing mode may be a passive stereo depth sensing mode. In response to detecting a quality value below a threshold level, the depth determination module 250 may use a depth sensing mode which utilizes a higher power requirement, such as an active stereo or structured stereo depth sensing mode. In some embodiments, in response to detecting a quality value above a threshold level, the depth determination module 250 may switch to a depth sensing mode which uses a lower power requirement, such as switching from an active stereo to a passive stereo depth sensing mode. In some embodiments, the depth determination module 250 may use a selected depth sensing mode for a portion of the field of view of the camera assembly 220, which may decrease power consumption as opposed to using the depth sensing mode for the full field of view.

The depth determination module 250 may select a depth sensing mode based on one or more depth sensing conditions for regions of the local area. For example, the depth sensing conditions may include an expected ambient light level. The expected ambient light level may be based on previously observed ambient light levels for the local area, geographic information about the local area, a time of day of the depth measurement, a weather report for the local area, or some combination thereof. For example, the depth sensing conditions may indicate that the local area is outdoors in a sunny environment. The depth sensing conditions may include a contrast level within a region of the local area. For example, a region of the local area may comprise a wall with little three-dimensional variation, and the depth sensing conditions may indicate a low contrast level in the region. The depth sensing conditions may comprise locations of objects within the local area. The depth determination module 250 may receive a suggested depth sensing mode from a mapping server.

The depth determination module 250 may select a depth sensing mode based on an activity being performed by the headset. For example, a virtual reality application may indicate that a high level of depth accuracy is desired, and the depth determination module 250 may select a structured stereo depth sensing mode, or a virtual reality application may indicate that the benefits of high resolution depth information do not outweigh the power costs of adding light to a region, and the depth determination module 250 may select a passive stereo depth sensing mode. In some embodiments, an application may indicate a minimum level of desired depth resolution, and the depth determination module 250 may select a depth sensing mode which meets the minimum depth resolution but uses the least power of modes that meet the standard.

The depth determination module 250 is configured to provide instructions to the illuminator 210. The depth determination module 250 is configured to instruct the illuminator 210 to emit light into the local area. In a TOF depth sensing mode, the depth determination module 250 may instruct the illuminator 210 to emit light pulses. The light pulses may comprise IR light illuminating the field of view of the illuminator 210, a structured light pattern, or some combination thereof. In a passive stereo mode, the depth determination module 250 may instruct the illuminator 210 to be inactive, and the depth determination module 250 may calculate depth information using a stereo matching algorithm. In an active stereo mode, the depth determination module 250 may instruct the illuminator 210 to emit a light pattern, uniform IR radiation, or some combination thereof into the local area, and the added texture from the light may increase the quality level of depth information calculated using the stereo matching algorithm. In a structured stereo mode, the depth determination module 250 may instruct the illuminator 210 to emit a structured light pattern, such as a grid, and the depth determination module 250 may calculate depth information based on distortions in the structure light pattern using a structured stereo matching algorithm. The depth determination module 250 may instruct the illuminator 210 to emit light into only a portion of the local area. The depth determination module 250 may instruct the illuminator 210 to emit different types of light into different portions of the local area for different depth sensing modes.

The depth determination module 250 updates a depth model using the measured depth information. The depth determination module 250 may update a depth model stored in the data store 240. The depth determination module 250 may generate a new depth model for the local area if the data store 240 does not contain a depth model for the local area. The depth determination module 250 may update depth information and depth sensing conditions in the depth model.

The depth determination module 250 may update the depth model for the local area by utilizing a machine learning model to generate a refined depth model. The depth determination module 250 determines a set of inputs to input into the machine learning model. For example, the depth determination module 250 may determine the set of inputs includes the set of captured images, a set of rectified captured images, the depth model, and the associated confidence map.

The depth determination module 250 determines the associated confidence map by determining a confidence value for each pixel of the corresponding depth model. For example, the depth determination module 250 compares the depth model to the set of captured images and assigns a confidence value to each pixel of the depth model based on the comparison. In some embodiments, the depth determination module 250 may determine to update the depth model based on the confidence map. For example, the depth determination module 250 may compare the confidence values in the confidence map to a confidence threshold value. If any of the confidence values are below the confidence threshold value, the depth determination module 250 determines to update the depth model to the refined depth model. In another example, the depth determination module 250 may determine how many confidence values in the confidence map are below the confidence threshold value. If the amount of confidence values that are below the confidence threshold value exceeds a quantity threshold, the depth determination module 250 determines to update the depth model to the refined depth model.

The depth determination module 250 determines the set of rectified captured images by rectifying the set of captured images. The depth determination module 250 rectifies the set of captured images by performing one or more conversions on the set of captured images. The one or more conversions are based on the one or more camera parameters of the camera assembly 220. For example, the one or more camera parameters may include intrinsic parameters, extrinsic parameters, and/or a distortion model for the camera assembly 220. In some embodiments, prior to the depth determination module 250 generating or updating a depth model, the depth determination module 250 determines the set of rectified captured images. The depth determination module 250 uses the set of rectified captured images to generate or update the depth model.

The depth determination module 250 may filter the depth model and the associated confidence map prior to including the depth model and the confidence map in the set of inputs for the machine learning model. The depth determination module 250 filters the depth model and the associated confidence map to correct any unwanted elements found in the depth model (and associated confidence map).

The depth determination module 250 provide the set of inputs to the machine learning model to generate the refined depth model. The refined depth model may differ from the depth model in one or more portions. The machine learning model may be a neural network, a deep learning model, a convolutional neural network, etc. The machine learning model may have a convolutional neural network architecture, such as a U-Net architecture, a ResNet architecture, or a combination thereof. The machine learning model may be trained using supervised or unsupervised learning methods. The application of the machine learning model is described in more detail in FIGS. 6A-6C. Based on the refined depth model, the depth determination module 250 can update depth measurements for the local area.

The calibration module 260 is configured to calibrate the DCA 200. The calibration module 260 may be configured to calibrate the cameras of the camera assembly 220 using the depth information obtained by the depth determination module 250. The controller 230 may obtain depth information for a region using multiple depth sensing modes. For example, the controller 230 may obtain a first set of depth information using a structured light mode using a first camera and the illuminator. The controller 230 may obtain a second set of depth information using a structured light mode using a second camera and the illuminator. The controller 230 may obtain a third set of depth information using a stereo depth sensing mode. In response to detecting a difference between expected measurements, the calibration module 260 may determine that the cameras should be calibrated, and the calibration module 260 may adjust a stereo depth matching algorithm to account for the discrepancy.

Small changes in the relative angle between the cameras and the illuminator 210 can result in significant discrepancies in depth measurements, particularly for stereo depth sensing modes. By calibrating the DCA 200 using multiple cameras, the DCA 200 may be recalibrated internally, in some cases without input from a user or external system. Thus, the calibration may increase the quality of depth measurements without impacting the availability to use a headset containing the DCA 200.

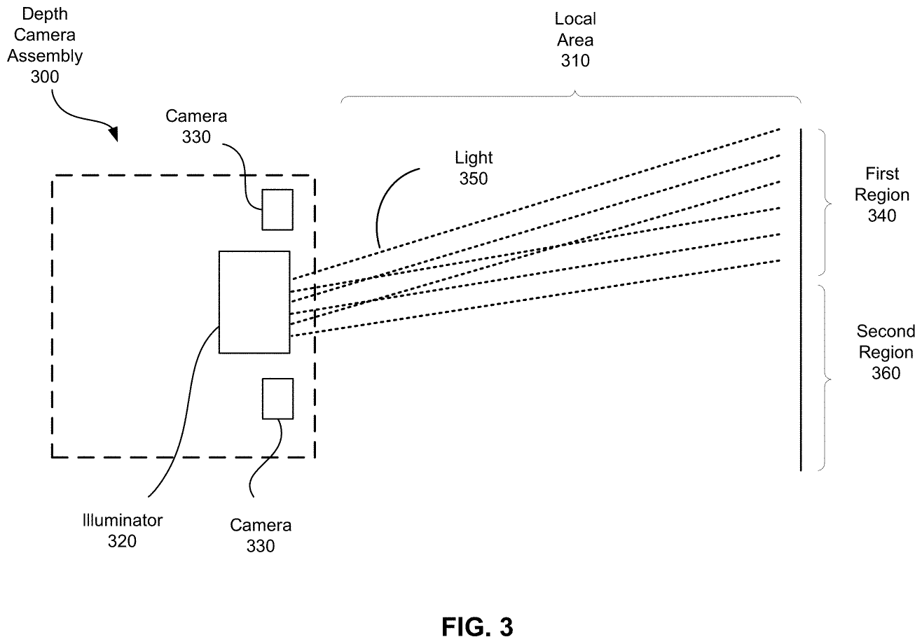

FIG. 3 is a schematic diagram of a depth camera assembly (DCA) 300 obtaining depth information in a local area 310, in accordance with one or more embodiments. The DCA 300 may be an embodiment of the DCA 200 of FIG. 2. The DCA 300 comprises an illuminator 320 and two cameras 330. The DCA 300 obtains depth measurements using an initial mode. The initial mode may be based on a depth sensing condition. The depth sensing condition may be an environmental condition. An environmental condition describes a property of the local area. An environmental condition may be, e.g., an ambient light level, a location of objects in the local area, a level of contrast of objects in the local area, some other property of the local area, or some combination thereof. For example, the DCA 300 may detect a high amount of ambient light in the local area 310, and the DCA 300 may select a passive stereo mode as the initial depth sensing mode. The initial mode may be based on an activity being performed by the DCA 300. The DCA 300 may detect a quality level of the depth measurements below a threshold level in a first region 340. For example, the DCA 300 may detect an uncertainty greater than a percentage of the depth (e.g., greater than 10% of the measured distance), or an uncertainty greater than a maximum distance (e.g., greater than one meter). In response to detecting the quality level is below the threshold level, the DCA 300 may select a different depth sensing mode for the first region 340. For example, the DCA 300 may select an active stereo mode, and the illuminator 320 may project light into the first region 340.

The DCA 300 may use different depth sensing modes for different portions of the local area 310. For example, the first region 340 may be located in a shadow, and the second region 360 may be located in a well-lit area. In another example, the first region 340 may comprise a smooth wall with minimal texture, and the second region 360 may comprise multiple objects located at different depths relative to the DCA 300. The DCA 300 may determine that a structured stereo mode should be used in a first region 340, and the illuminator 320 may project light 350 into the first region 340. However, the DCA 300 may determine that a passive stereo mode should be used in a second region 360, and the DCA 300 may not project light into the second region 360. Thus, the DCA 300 may decrease power usage while obtaining desired depth resolution in different regions of the local area 310. In some embodiments, the depth information may be determined for both the first region 340 and the second region 360 simultaneously. In some embodiments, the depth information may be determined for the first region 340 and the second region 360 sequentially.

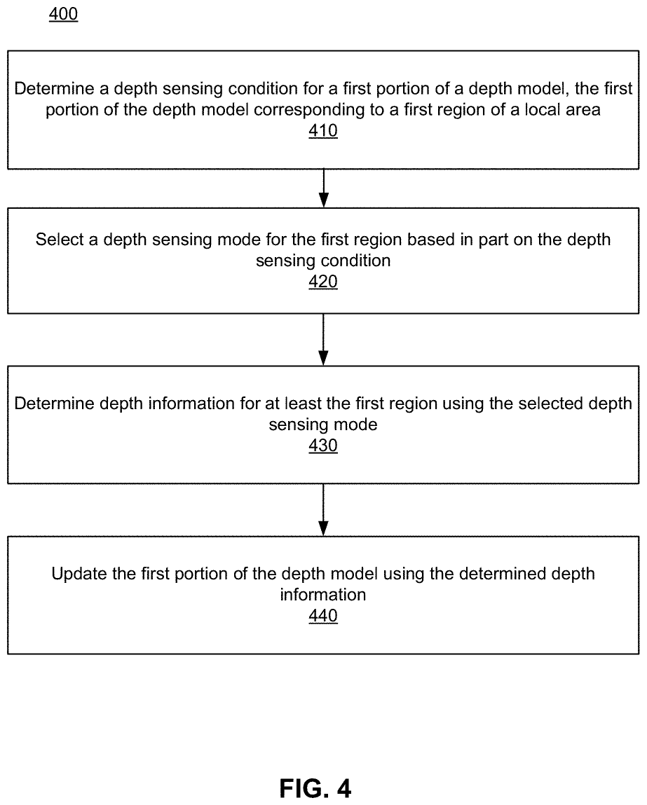

FIG. 4 is a flowchart of a method 400 of calculating a depth to an object, in accordance with one or more embodiments. The process shown in FIG. 4 may be performed by components of a DCA (e.g., DCA 200 of FIG. 2). Other entities may perform some or all of the steps in FIG. 4 in other embodiments. Embodiments may include different and/or additional steps or perform the steps in different orders.

The DCA determines 410 a depth sensing condition for a first portion of a depth model. The first portion of the depth model corresponds to a first region of a local area. The depth sensing condition may be determined based on an environmental condition detected by the DCA. For example, a camera of the DCA may detect an amount of ambient light in the local area. In some embodiments, the DCA may comprise a photosensor that detects ambient light. In some embodiments, the DCA may determine the depth sensing condition based on information stored in a depth model. For example, a depth model stored locally on the DCA or stored by a mapping server may provide a previously measured quality level (e.g., ambient light level and/or contrast level) of objects in the local area. The depth model may indicate a suggested depth sensing mode for the local area.

The DCA selects 420 a depth sensing mode for the first region based in part on the depth sensing condition. The depth sensing mode is selected from a plurality of different depth sensing modes. The depth sensing mode may be TOF depth sensing, structured light depth sensing, passive stereo depth sensing, active stereo depth sensing, structured stereo depth sensing, or some combination thereof. The DCA may select multiple depth sensing modes, each of which may be selected for a different region of the local area. For example, in a first region of the local area having a high level of ambient light, the DCA may select a passive stereo mode, and in a second region of the local area having a lower level of ambient light, the DCA may select an active stereo mode.

The DCA determines 430 depth information for at least the first region using the selected depth sensing mode. The DCA may calculate a distance to an object in the first region based on the selected depth sensing mode. The DCA may calculate distances to all objects in the field of view of the DCA. The DCA may calculate a distance for each pixel of the cameras of the DCA. The DCA may modify the depth sensing modes based on the calculated distances. For example, in response to detecting a quality level below a threshold level for depth measurements in the first region, the DCA may change a depth sensing mode for the first region from passive stereo to active stereo.

The DCA updates 440 the first portion of the depth model using the determined depth information. The DCA may update the depth model locally, provide the depth information to a depth mapping server for updating the depth model, or some combination thereof. In some embodiments, the depth information may replace previously obtained depth information. In other embodiments, the depth information may be stored for regions without previously stored depth information. The depth information may be determined by one depth sensing mode and may replace depth information obtained by a different depth sensing mode.

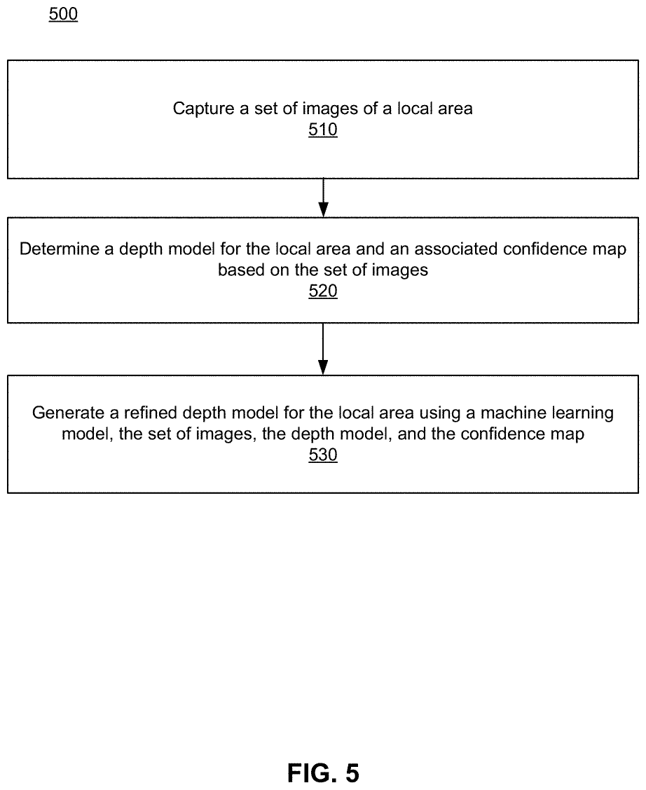

FIG. 5 is a flowchart of a method 500 of updating a depth model using a machine learning model, in accordance with one or more embodiments. The process shown in FIG. 5 may be performed by components of a DCA (e.g., the DCA 200 of FIG. 2). Other entities may perform some or all of the steps in FIG. 5 in other embodiments. Embodiments may include different and/or additional steps or perform the steps in different orders.

The DCA captures 510 a set of images of a local area from a plurality of cameras. For example, the DCA may provide instructions to a camera assembly (e.g., the camera assembly 220) to capture the set of images of the local area. In some embodiments, at least some of the plurality of cameras are configured to have overlapping fields of view. The DCA may provide instruction to an illuminator (e.g., the illuminator 210) to illuminate the local area during image capture. For example, based on a depth sensing mode, the DCA may instruct the illuminator to emit a certain type of light into the local area.

The DCA determines 520 a depth model for the local area and an associated confidence map based on the set of captured images. For example, the DCA may determine depth model based on the depth sensing mode. The DCA may calculate a distance to an object in the local area or calculate distances to all objects in the field of view of the DCA based on the depth sensing mode. The DCA may calculate a distance for each pixel of the cameras of the DCA. The DCA determines the depth model based on the calculated distances. The DCA determines an associated confidence map based on the set of captured images. The DCA determines the associated confidence map by determining a confidence value for each pixel of the corresponding depth model. For example, the DCA compares the depth model to the set of captured images and assigns a confidence value to each pixel of the depth model based on the comparison.

The DCA generates 530 a refined depth model for the local area using a machine learning model, the set of images, the depth model, and the confidence map. The DCA provides as inputs to the machine learning model the set of images, the depth model, and the confidence map. The machine learning model may be a neural network, a deep learning model, a convolutional neural network, etc. In some embodiments, the machine learning model may have a convolutional neural network architecture, such as a U-Net architecture, a ResNet architecture, or a combination thereof. The architecture of the machine learning model may use less power to perform the generation of the refined depth model that is highly accurate by performing several compressions of the inputs in a spatial dimension while simultaneously refining the inputs in a depth dimension.

FIG. 6A is a process flow diagram 600 for a machine learning model 630, in accordance with one or more embodiments. The machine learning model 630 may be utilized by a DCA (e.g., the DCA 200) to update a depth model for a local area. The process flow diagram 600 includes a set of inputs 605, the machine learning model 630, and an output 635. The set of inputs 605 includes a set of images 610 of a local area, a depth model 615, and a confidence map 620. The set of images 610 may be captured by a camera assembly (e.g., the camera assembly 220) of the DCA. In some embodiments, the set of images 610 may be a set of rectified images. The depth model 615 may be determined by a controller (e.g., the controller 230) based on the set of images 610. The confidence map 620 may be determined by the controller based on the set of images 610. For example, the depth model 615 may be a disparity map. The controller may determine a confidence level for each pixel depicted in the depth model 615 based on a corresponding pixel in the set of images 610. In some embodiments, the depth model 615 and the confidence map 620 may be filtered by the controller prior to being input into the machine learning model 630.

The machine learning model 630 generates the output 635. The output 635 includes a refined depth model 640. The machine learning model 630 may use a convolutional neural network architecture, such as a U-Net architecture, a ResNet architecture, or a combination thereof. An example architecture is further discussed below with regard to FIG. 6B.

The refined depth model 640 may be utilized by the controller to determine depth measurements for the local area. The depth measurements may be utilized by a device (e.g., a headset) that the DCA is a component of to determine and/or augment content provided to a user of the device.

FIG. 6B illustrates an example architecture for the machine learning model 630 of FIG. 6A. The example architecture is a combination of a U-Net architecture and a ResNet architecture. The set of inputs 605, such as the set of images 610, the depth model 615, and the associated confidence map 620, are input into one path, i.e. a contracting path 653. The contracting path 653 follows an architecture of a convolutional network. The contracting path 653 consists of a repeated application of convolutions for downsampling and is illustrated in FIG. 6B with a progression of downsample stages 650 (e.g., a downsample stage 650A, a downsample stage 650B, a downsample stage 650C, a downsample stage 650D, and a downsample stage 650E). The contracting path 653 may include any number of downsample stages 650. At each downsample stage 650A, 650B, 650C, 650D, 650E, the machine learning model 630 decreases the set of inputs 605 in a spatial dimension by two (e.g., a 160×120 spatial dimension is downscaled to an 80×60 spatial dimension) and increases feature channels in a depth dimension. By downsampling the set of inputs 605, the machine learning model 630 decreases a size of the input signal by lowering its sampling rate or sample size (bits per sample). Each downsample stage 650A, 650B, 650C, 650D, 650E may consist of two or more repetitive operations applied to the set of inputs 605 as the set progresses through the contracting path 653. The repetitive operations can include the application of convolutions and rectified linear units (ReLU).

In an expanding path 655, a repeated application of convolutions for upsampling is applied by the machine learning model and is illustrated in FIG. 6B with a progression of convolution stages 660 (e.g., a convolution stage 660A, a convolution stage 660B, a convolution stage 660C, a convolution stage 660D, a convolution stage 660E, and a convolution stage 660F) and upsample stages 670 (e.g., an upsample stage 670A, an upsample stage 670B, an upsample stage 670C, an upsample stage 670D, and an upsample stage 670E). The expanding path 655 may include any number of convolution stages 660 and upsample stages 670. Each convolution stage 660A, 660B, 660C, 660D, 660E, 660F includes applications of convolutions and ReLU. In one embodiment, each upsample stage 670A, 670B, 670C, 670D, 670E includes applications of upscaling by two using convolutions (e.g., an 80×60 spatial dimension is upscaled to a 160×120 spatial dimension) and decreasing feature channels in the depth dimension. In another embodiment, each upsample stage 670A, 670B, 670C, 670D, 670E includes applications of transpose convolutions. In another embodiment, each upsample stage 670A, 670B, 670C, 670D, 670E includes applications of a combination of upscaling, interpolation, and convolution. In one embodiment, the arrows connecting the contracting path 653 and the expanding path 655 represent a concatenation of the upsampling with the corresponding downsample from the contracting path 653. In another embodiment, the arrows connecting the contracting path 653 and the expanding path 655 represent an add and/or multiply operation for runtime efficiency. In one embodiment, the last upsample stage 670E includes a ReLU or sigmoid operation. The output 635 is the refined depth model 640. The refined depth model 640 may have the same dimension as the set of inputs 605 due to an equal number of downsample and upsample stages 650 and 670.

FIG. 6C illustrates example inputs and an example output for the machine learning model 630 of FIG. 6A. The example inputs include an example image 612 and an example depth model 617. The example output includes an example refined depth model 642. The example image 612 is an example of one image in a set of images 610 of the local area. The example depth model 617 is an example of the depth model 615 determined by the controller (e.g., the controller 230). The example depth model 617 is depicted with a color-scale representing different depths of objects (or of surfaces of objects) within the local area. The example refined depth model 642 is an example of the refined depth model 640 determined by the machine learning model 630. The example refined depth model 642 is also depicted with a color-scale representing different depths of objects (or of surfaces of objects) within the local area. As described above, the machine learning model 630 accepts as inputs the set of images 610 (e.g., including the example image 612), the depth model 615 (e.g., the example depth model 617), and an associated confidence map (not shown) and outputs the refined depth model 640 (e.g., the example refined depth model 642).

FIG. 7 is a flowchart of a method 700 of calibrating a DCA, in accordance with one or more embodiments. The process shown in FIG. 7 may be performed by components of a DCA (e.g., the DCA 200 of FIG. 2). Other entities may perform some or all of the steps in FIG. 7 in other embodiments. Embodiments may include different and/or additional steps or perform the steps in different orders.

The DCA projects 710 a structured light pattern onto an object. The structured light pattern may comprise, e.g., a pattern of dots or bars. The structured light pattern is configured to be detected by at least two cameras of the DCA.

The DCA calculates 720, based on distortions of the structured light pattern in an image captured by a first camera in the DCA, a first depth measurement to the object. The DCA may calculate a depth value for each pixel of the DCA.

The DCA calculates 730, based on distortions of the structured light pattern in an image captured by a second camera in the DCA, a second depth measurement to the object. The second depth measurement may be calculated simultaneous to the calculation of the first depth measurement.

The DCA calculates 740, using a stereo depth sensing mode for the image captured by the first sensor and the image captured by the second sensor, a third depth measurement to the object. The third depth measurement may be calculated simultaneous to the calculation of the first depth measurement and the second depth measurement. In some embodiments, one or more depth measurements may be taken using other depth sensing modes. For example, the DCA may calculate depth measurements to the object for each camera using a TOF mode.

The DCA calibrates 750, based on differences between the first depth measurement, the second depth measurement, and the third depth measurement, the DCA. The cameras of the DCA may have been originally calibrated in a factory setting. However, due to various events, such as bending of a device containing the DCA, or an external object contacting and moving a camera of the DCA, the relative positioning of the cameras and illuminator of the DCA may change over time. Based on the depth measurement values obtained by the DCA, the DCA may determine the current relative positions of the cameras, and the DCA may calibrate the DCA such that the cameras may be used accurately for stereo depth sensing modes. In some embodiments, the DCA may determine that the two depth measurements having the most similar values are more likely to be accurate, and the system having the third measurement may be recalibrated. In some embodiments, the DCA may determine that the depth measurements for the image captured by the first camera and the image captured by the second camera have similar values but in different locations of the sensors of the cameras. For example, the image captured by the first camera may be shifted by an angle relative to the image captured by the second camera. The DCA may calibrate the DCA by compensating for the angular shift when calculating depth information in stereo depth sensing modes.

FIG. 8 is a system 800 that includes a headset 805, in accordance with one or more embodiments. In some embodiments, the headset 805 may be the headset 100 of FIG. 1A or the headset 105 of FIG. 1B. The system 800 may operate in an artificial reality environment (e.g., a virtual reality environment, an augmented reality environment, a mixed reality environment, or some combination thereof). The system 800 shown by FIG. 8 includes the headset 805, an input/output (I/O) interface 810 that is coupled to a console 815, the network 820, and the mapping server 825. While FIG. 8 shows an example system 800 including one headset 805 and one I/O interface 810, in other embodiments any number of these components may be included in the system 800. For example, there may be multiple headsets each having an associated I/O interface 810, with each headset and I/O interface 810 communicating with the console 815. In alternative configurations, different and/or additional components may be included in the system 800. Additionally, functionality described in conjunction with one or more of the components shown in FIG. 8 may be distributed among the components in a different manner than described in conjunction with FIG. 8 in some embodiments. For example, some or all of the functionality of the console 815 may be provided by the headset 805.

The headset 805 includes the display assembly 830, an optics block 835, one or more position sensors 840, and the DCA 845. Some embodiments of headset 805 have different components than those described in conjunction with FIG. 8. Additionally, the functionality provided by various components described in conjunction with FIG. 8 may be differently distributed among the components of the headset 805 in other embodiments or be captured in separate assemblies remote from the headset 805.

The display assembly 830 displays content to the user in accordance with data received from the console 815. The display assembly 830 displays the content using one or more display elements (e.g., the display elements 120). A display element may be, e.g., an electronic display. In various embodiments, the display assembly 830 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element may also include some or all of the functionality of the optics block 835.

The optics block 835 may magnify image light received from the electronic display, corrects optical errors associated with the image light, and presents the corrected image light to one or both eyeboxes of the headset 805. In various embodiments, the optics block 835 includes one or more optical elements. Example optical elements included in the optics block 835 include: an aperture, a Fresnel lens, a convex lens, a concave lens, a filter, a reflecting surface, or any other suitable optical element that affects image light. Moreover, the optics block 835 may include combinations of different optical elements. In some embodiments, one or more of the optical elements in the optics block 835 may have one or more coatings, such as partially reflective or anti-reflective coatings.

Magnification and focusing of the image light by the optics block 835 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 835 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 835 corrects the distortion when it receives image light from the electronic display generated based on the content.

The position sensor 840 is an electronic device that generates data indicating a position of the headset 805. The position sensor 840 generates one or more measurement signals in response to motion of the headset 805. The position sensor 190 is an embodiment of the position sensor 840. Examples of a position sensor 840 include: one or more IMUS, one or more accelerometers, one or more gyroscopes, one or more magnetometers, another suitable type of sensor that detects motion, or some combination thereof. The position sensor 840 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 805 from the sampled data. For example, the IMU integrates the measurement signals received from the accelerometers over time to estimate a velocity vector and integrates the velocity vector over time to determine an estimated position of a reference point on the headset 805. The reference point is a point that may be used to describe the position of the headset 805. While the reference point may generally be defined as a point in space, however, in practice the reference point is defined as a point within the headset 805.

The DCA 845 generates and/or updates depth information for a portion of the local area. The DCA 845 may be an embodiment of the DCA 200 of FIG. 2. The DCA 845 includes one or more imaging devices, an illuminator, and a DCA controller. Operation and structure of the DCA 845 is described above primarily with regard to, e.g., FIGS. 2-7. The DCA 845 may select different depth sensing modes based on depth sensing conditions, such as environmental conditions detected by the headset, an activity being performed by the headset 805, or some combination thereof. In some embodiments, the depth sensing modes may be determined based at least in part on information provided by the mapping server 825. The DCA 845 may determine to update a depth model of the local area. The DCA 845 may update the depth model by utilizing a different depth sensing mode and/or by utilizing a machine learning model.

The audio system 850 provides audio content to a user of the headset 805. The audio system 850 may comprise one or acoustic sensors, one or more transducers, and an audio controller. The audio system 850 may provide spatialized audio content to the user. In some embodiments, the audio system 850 may request acoustic parameters from the mapping server 825 over the network 820. The acoustic parameters describe one or more acoustic properties (e.g., room impulse response, a reverberation time, a reverberation level, etc.) of the local area. The audio system 850 may provide information describing at least a portion of the local area from e.g., the DCA 845 and/or location information for the headset 805 from the position sensor 840. The audio system 850 may generate one or more sound filters using one or more of the acoustic parameters received from the mapping server 825 and use the sound filters to provide audio content to the user.

The I/O interface 810 is a device that allows a user to send action requests and receive responses from the console 815. An action request is a request to perform a particular action. For example, an action request may be an instruction to start or end capture of image or video data, or an instruction to perform a particular action within an application. The I/O interface 810 may include one or more input devices. Example input devices include: a keyboard, a mouse, a game controller, or any other suitable device for receiving action requests and communicating the action requests to the console 815. An action request received by the I/O interface 810 is communicated to the console 815, which performs an action corresponding to the action request. In some embodiments, the I/O interface 810 includes an IMU that captures calibration data indicating an estimated position of the I/O interface 810 relative to an initial position of the I/O interface 810. In some embodiments, the I/O interface 810 may provide haptic feedback to the user in accordance with instructions received from the console 815. For example, haptic feedback is provided when an action request is received, or the console 815 communicates instructions to the I/O interface 810 causing the I/O interface 810 to generate haptic feedback when the console 815 performs an action.

The console 815 provides content to the headset 805 for processing in accordance with information received from one or more of: the DCA 845, the headset 805, and the I/O interface 810. In the example shown in FIG. 8, the console 815 includes an application store 855, a tracking module 860, and an engine 865. Some embodiments of the console 815 have different modules or components than those described in conjunction with FIG. 8. Similarly, the functions further described below may be distributed among components of the console 815 in a different manner than described in conjunction with FIG. 8. In some embodiments, the functionality discussed herein with respect to the console 815 may be implemented in the headset 805, or a remote system.

The application store 855 stores one or more applications for execution by the console 815. An application is a group of instructions, that when executed by a processor, generates content for presentation to the user. Content generated by an application may be in response to inputs received from the user via movement of the headset 805 or the I/O interface 810. Examples of applications include: gaming applications, conferencing applications, video playback applications, or other suitable applications.

The tracking module 860 tracks movements of the headset 805 or of the I/O interface 810 using information from the DCA 845, the one or more position sensors 840, or some combination thereof. For example, the tracking module 860 determines a position of a reference point of the headset 805 in a mapping of a local area based on information from the headset 805. The tracking module 860 may also determine positions of an object or virtual object. Additionally, in some embodiments, the tracking module 860 may use portions of data indicating a position of the headset 805 from the position sensor 840 as well as representations of the local area from the DCA 845 to predict a future location of the headset 805. The tracking module 860 provides the estimated or predicted future position of the headset 805 or the I/O interface 810 to the engine 865.

The engine 865 executes applications and receives position information, acceleration information, velocity information, predicted future positions, or some combination thereof, of the headset 805 from the tracking module 860. Based on the received information, the engine 865 determines content to provide to the headset 805 for presentation to the user. For example, if the received information indicates that the user has looked to the left, the engine 865 generates content for the headset 805 that mirrors the user's movement in a virtual local area or in a local area augmenting the local area with additional content. Additionally, the engine 865 performs an action within an application executing on the console 815 in response to an action request received from the I/O interface 810 and provides feedback to the user that the action was performed. The provided feedback may be visual or audible feedback via the headset 805 or haptic feedback via the I/O interface 810.

The network 820 couples the headset 805 and/or the console 815 to the mapping server 825. The network 820 may include any combination of local area and/or wide area networks using both wireless and/or wired communication systems. For example, the network 820 may include the Internet, as well as mobile telephone networks. In one embodiment, the network 820 uses standard communications technologies and/or protocols. Hence, the network 820 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 820 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 820 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 825 may include a database that stores a virtual model describing a plurality of spaces, wherein one location in the virtual model corresponds to a current configuration of a local area of the headset 805. The mapping server 825 stores one or more depth models describing the local area. The depth model may describe, e.g., depth information for the local area, environmental conditions of the local area, some other information describing the local area, or some combination thereof. The mapping server 825 receives, from the headset 805 via the network 820, information describing at least a portion of the local area and/or location information for the local area. The user may adjust privacy settings to allow or prevent the headset 805 from transmitting information to the mapping server 825. The mapping server 825 determines, based on the received information and/or location information, a location in the virtual model that is associated with the local area of the headset 805. The mapping server 825 determines (e.g., retrieves) one or more parameters associated with the local area, based in part on the determined location in the virtual model and any parameters associated with the determined location. The mapping server 825 may transmit the location of the local area and any values of parameters associated with the local area to the headset 805. The mapping server 825 may provide a suggested depth sensing mode to the headset 805 for at least one region of the local area. The mapping server 825 may update one or more depth models based on depth information received from the headset 805.

One or more components of system 800 may contain a privacy module that stores one or more privacy settings for user data elements. The user data elements describe the user or the headset 805. For example, the user data elements may describe a physical characteristic of the user, an action performed by the user, a location of the user of the headset 805, a location of the headset 805, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 800 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
determining a depth sensing condition for a first portion of a depth model, the first portion of the depth model corresponding to a first region of a local area;
selecting, by a depth camera assembly (DCA), a depth sensing mode for the first region based in part on the depth sensing condition, wherein the depth sensing mode is selected from a plurality of different depth sensing modes;
determining, by the DCA, depth information for at least the first region using the selected depth sensing mode; and
updating the first portion of the depth model using the determined depth information.

2. The method of claim 1, wherein the depth sensing mode comprises at least one of a passive stereo mode, an active stereo mode, or a structured stereo mode.

3. The method of claim 1, further comprising determining an uncertainty value for the depth information.

4. The method of claim 3, further comprising changing, based on the uncertainty value, the depth sensing mode for the first region.

5. The method of claim 1, further comprising selecting a depth sensing mode for a second region of the local area, wherein the depth sensing mode for the second region is different than the depth sensing mode for the first region.

6. The method of claim 1, the method further comprising:
receiving a set of captured images of the first region of the local area;
determining a confidence map corresponding to the depth model based on the set of captured images; and
generating a refined depth model for the local area using a machine learning model and the depth model, the confidence map, and the set of captured images.

7. The method of claim 1, further comprising:
providing a location of the DCA to a depth mapping server; and
receiving the depth sensing condition from the depth mapping server.

8. A depth camera assembly (DCA) comprising:
a first camera;
a second camera;
an illuminator; and
a controller, the controller configured to:
determine a depth sensing condition for a first region of a local area;
select a depth sensing mode for the first region based in part on the depth sensing condition;
instruct the illuminator to project light into the first region based on the depth sensing mode; and
obtain depth information for the first region based on reflected light detected by the first camera and the second camera.

9. The DCA of claim 8, wherein the depth sensing mode comprises at least one of a passive stereo mode, an active stereo mode, or a structured stereo mode.

10. The DCA of claim 8, wherein the controller is further configured to determine an uncertainty value for the depth information.

11. The DCA of claim 10, wherein the controller is further configured to change, based on the uncertainty value, the depth sensing mode for the first region.

12. The DCA of claim 8, wherein the controller is further configured to select a depth sensing mode for a second region of the local area, wherein the depth sensing mode for the second region is different than the depth sensing mode for the first region.

13. The DCA of claim 8, wherein the reflected light detected by the first camera and the second camera is a set of images of the local area, the controller is further configured to:
determine a depth model for the local area based in part on the depth information for the first region;
determine a confidence map that corresponds to the depth model based on the set of images; and
determine a refined depth model for the local area using a machine learning model and the depth model, the confidence map, and the set of images.

14. The DCA of claim 8, wherein the controller is further configured to calibrate the DCA based on a first depth measurement obtained using the first camera and a second depth measurement obtained using the second camera.

15. A computer program product comprising a non-transitory computer-readable storage medium containing computer program code that comprises:
a depth selection module configured to:
determine a depth sensing condition for a first portion of a depth model, the first portion of the depth model corresponding to a first region of a local area; and
select a depth sensing mode for the first region based in part on the depth sensing condition, wherein the depth sensing mode is selected from a plurality of different depth sensing modes;
a depth measurement module configured to determine depth information for at least the first region using the selected depth sensing mode; and
a depth mapping module configured to update the first portion of the depth model using the determined depth information.

16. The computer program product of claim 15, wherein the depth mapping module is configured to update the depth model by using a machine learning model to generate a refined depth model.

17. The computer program product of claim 15, wherein the depth measurement module is configured to determine an uncertainty value for the depth information.

18. The computer program product of claim 17, wherein the depth selection module is configured to change, based on the uncertainty value, the depth sensing mode for the first region.

19. The computer program product of claim 15, wherein the depth selection module is configured to select a depth sensing mode for a second region of the local area, wherein the depth sensing mode for the second region is different than the depth sensing mode for the first region.

20. The computer program product of claim 15, wherein the depth measurement module is configured to instruct an illuminator to project light into the first region, wherein a pattern of the light is selected based on the depth sensing mode.
